(19) United States
(12) Patent Application Publication
(10) Pub. No.: US 2005/0053348 A1
(43) Pub. Date: Mar. 10, 2005

(54) Optical waveguide and method of manufacturing the same

(76) Inventors: Naoki Tatehata, Osaka (JP); Shigeo Furukawa, Osaka (JP)

Correspondence Address: ROSSI & ASSOCIATES, P.O. BOX 826, ASHBURN, VA, 20146-0826, US

(21) Appl. No.: 10/890,552

(22) Filed: Jul. 13, 2004

(30) Foreign Application Priority Data
Jul. 16, 2003 (JP) JP 2003-197555

(51) Int. Cl. G02B 6/10

(52) U.S. Cl. 385/129

(57) ABSTRACT

An optical waveguide includes a first cladding layer made of glass material, a core made of glass material on the first cladding layer, and a second cladding layer covering the core and made of glass material including at least one of alkali element, alkali-earth element, and rare-earth element. The first cladding layer has a first softening temperature and a first refraction index. The core has a second refraction index larger than the first refraction index. The second cladding layer has a second softening temperature lower than the first softening temperature, and has a third refraction index smaller than the second refraction index. The optical waveguide is manufactured at high productivity since the second cladding layer does not deform.

### FIELD OF THE INVENTION

The present invention relates to an optical waveguide for use in optical communication systems and to a method of manufacturing the optical wayveguide.

### BACKGROUND OF THE INVENTION

FIGS. 5A to 5I are cross-sectional views of a conventional optical waveguide for illustrating a conventional method for manufacturing the waveguide disclosed in Japanese Patent Laid-Open Publication No.11-84157.

Lower cladding layer 12 is formed on substrate 11 shown in FIG. 5A by deposition or the like, as shown in FIG. 5B. Core layer 15 is formed on lower cladding layer 12 by deposition, as shown in FIG. 5C. Mask layer 16 is then formed on core layer 15, as shown in FIG. 5D, and resist-pattern 17 is formed on mask layer 16 by photolithography, as shown in FIG. 5E. Mask layer 16 is etched with reactive ion beam to provide mask pattern 18, and then, resist-pattern 17 is removed, as shown in FIG. 5F. Then, core layer 15 is etched with reactive ion beam to provide core 13, as shown in FIG. 5G, and then, mask pattern 18 is removed, as shown in FIG. 5H. Finally, upper cladding layer 14 is formed by deposition, as shown in FIG. 5I.

The conventional method described above requires no deformation of lower cladding layer 12 and core 13 while core 13 is covered with cladding layer 14. Upper cladding layer 14 may not cover core 13 completely if lower cladding layer 12 and core 13 deform. This causes a poor production yield resulting in a high cost of the optical waveguide.

It takes a long time to heat upper cladding layer 14 in order to have layer 14 cover core 13 after cladding layer 14 is formed on core 13. The long heating time reduces productivity of optical waveguide, hence resulting in higher production cost.

### SUMMARY OF THE INVENTION

An optical waveguide includes a first cladding layer made of glass material, a core made of glass material on the first cladding layer, and a second cladding layer covering the core and made of glass material including at least one of alkali element, alkali-earth element, and rare-earth element. The first cladding layer has a first softening temperature and a first refraction index. The core has a second refraction index larger than the first refraction index. The second cladding layer has a second softening temperature lower than the first softening temperature, and has a third refraction index smaller than the second refraction index. The optical waveguide is manufactured at high productivity since the second cladding layer does not deform.

### BRIEF DESCRIPTION OF THE DRAWINGS

FIG. 1A is a perspective view of an optical waveguide according to Exemplary Embodiments 1 and 2 of the present invention.

FIG. 1B is an exploded perspective view of the optical waveguide according to Embodiments 1 and 2.

FIGS. 2A to 2J are cross sectional views of the optical waveguide for illustrating processes of manufacturing the waveguide according to Embodiment 2.

FIGS. 3A and 3B are cross-sectional views of the optical waveguide according to Embodiment 2.

FIGS. 4A to 4G are cross-sectional views of the optical waveguide for illustrating processes of manufacturing the waveguide according to Embodiment 2.

FIGS. 5A to 5I are cross-sectional views of a conventional optical waveguide for illustrating processes of manufacturing the waveguide.

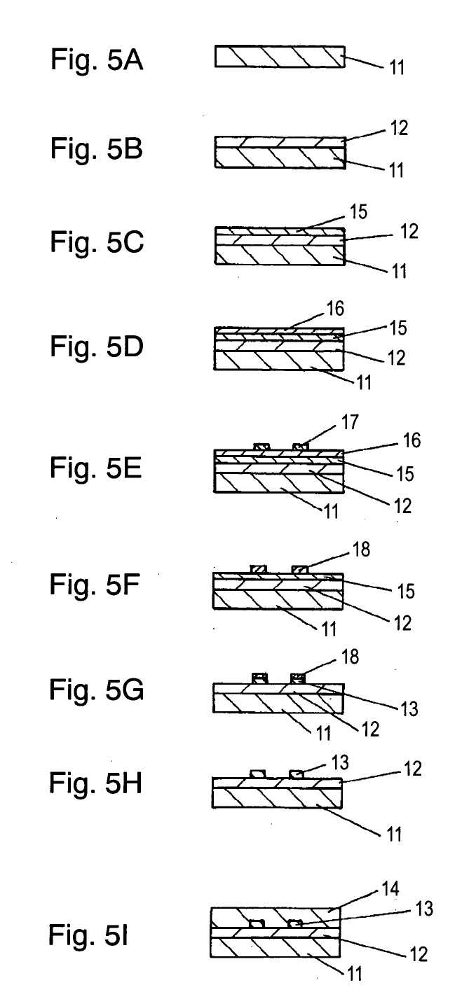

### DETAILED DESCRIPTION OF THE PREFERRED EMBODIMENTS

Exemplary Embodiment 1

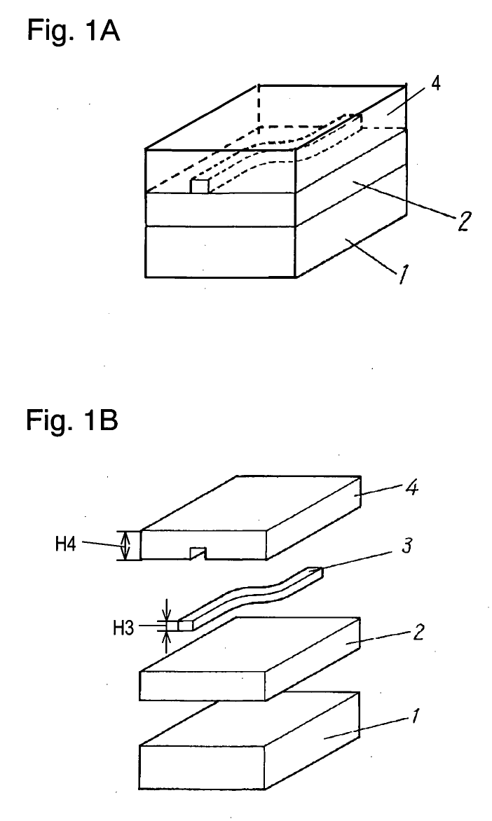

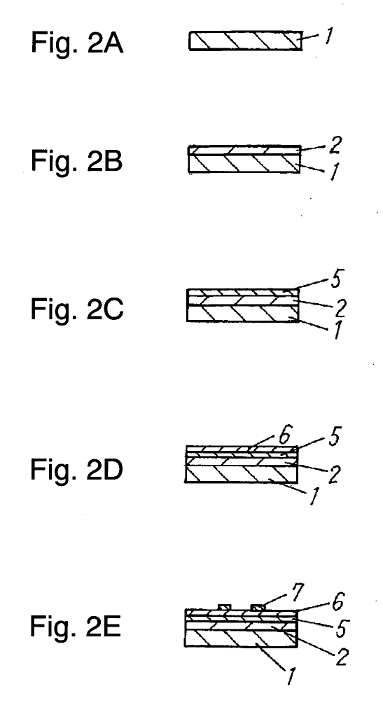

FIG. 1A is a perspective view of an optical waveguide according to Exemplary Embodiment 1 of the present invention. FIG. 1B is an exploded perspective view of the optical waveguide.

Substrate 1 is made of Si, SiO₂, or multi-component glass material. The multi-component glass material includes at least one of alkali element, alkali-earth element and rare-earth element, and may be borosilicate glass, such as BK7, which includes alkali element. The glass material may be fluorine crown glass, which includes many kinds of alkali element and fluorine

Physical properties, such as refraction index and thermal expansion coefficient, of ordinary silica glass made of SiO₂ are determined essentially according to physical properties of the silica glass included. The composition of the multi-component glass material is changed, accordingly changing physical properties of the glass material, such as a refraction index, a thermal expansion coefficient, and a transition temperature.

Lower cladding layer 2 provided on substrate 1 is composed of SiO₂ or glass material of other kind. Substrate 1 and lower cladding layer 2 preferably have their linear expansion coefficients close to each other. Having their linear expansion coefficients different from each other, substrate 1 and lower cladding layer 2 may be peeled cracked between them.

If substrate is made of Si, an SiO₂ layer may be formed on substrate 1 by oxidizing Si, hence functioning as lower cladding layer 2. If core 3 is made of multi-component glass material, lower cladding layer 2 may be made preferably of the multi-component glass material to manufacture the optical waveguide simply. Substrate 1 may be made of material identical to that of lower cladding layer 2.

Core 3 is composed of glass material having a refraction index slightly larger than that of lower cladding layer 2. Core 3 is preferably made of multi-component glass material to produce the optical waveguide simply. Upper cladding layer 4 is formed on core 3 provided on lower cladding layer 2 to cover core 3, thus providing the optical waveguide.

The cross-section of core 3 of the optical waveguide according to Embodiment 1 does not necessarily have a rectangular shape shown in FIG. 1B, but may have another shape, such as a trapezoid shape. FIGS. 1A and 1B show single core 3, however, the waveguide may include plural cores 3 having liner and curved shapes.

Upper cladding layer 4, similarly to lower cladding layer 2, is composed of material having a refraction index slightly smaller than that of core 3. Core 3 has a refraction index larger than refraction indexes of lower cladding layer 2 and upper cladding layer 4, hence making light stay in core 3 and propagate due to a difference between the refraction indexes.

For providing a single-mode optical waveguide, the refraction indexes of core 3, lower cladding layer 2, and upper cladding layer 4 are designed so that core 3 has height H3 rainging approximately from 5 μm to 10 μm. Thickness H4 of upper cladding layer 4 usually ranges approximately from 20 μm to 30 μm.

Upper cladding layer 4 composed of the multi-component glass material may be formed by a film-forming chemical method, such as chemical vapor deposition (CVD), or by a physical vapor deposition method such as sputtering.

The sputtering is preferable since providing a low production cost. In the case that upper cladding layer 4 is formed by the sputtering, a sputtering target of multi-component glass material having a desired composition provides upper cladding layer 4 made of the multi-component glass material having the desired composition. The composition of the target seldom matches with that of upper cladding layer 4 strictly, but substantially matches with that of upper cladding layer 4. Designing of the composition of the sputtering target is important to precisely control the physical properties of upper cladding layer 4, such as the refraction index and the thermal expansion coefficient.

Upper cladding layer 4 is heated to cover core 3 suhhicienly. Upper cladding layer 4 has a softening temperature lower than that of lower cladding layer 2. Practically, the optical waveguide is heated to soften upper cladding layer 4 at a temperature lower than the softening temperature of lower cladding layer 2 and higher than the softening temperature of upper cladding layer 4. This operation prevents lower cladding layer 2 from deforming.

A difference between the softening temperatures of lower cladding layer 2 and upper cladding layer 4 smaller than 50° C. is not preferable since a temperature for the heating needs to be precisely control. A difference of the softening temperatures not smaller than 50° C. reliably prevents lower cladding layer 2 from deforming, due to a large control tolerance of the heating temperature. Upper cladding layer 4 has a softening temperature lower than that of core 3, hence preventing core 3 from deforming during the heating process of upper cladding layer 4.

The difference between linear expansion coefficients of glass materials composing upper cladding layer 4 and core 3 may preferably be not smaller than 9×10⁻⁷K⁻¹. Similarly, the difference between linear expansion coefficients of glass materials composing upper cladding layer 4 and lower cladding layer 2 may preferably be not larger than 9×10⁻⁷K⁻¹. A large difference between the linear expansion coefficients often causes cracks during the heating process.

Silica glass is softened at a high temperature, for instance, pure silica glass has a high softening temperature not lower than 2,000° C. The silica glass is heated up to a temperature ranging from 1200° C. to 1700° C. to be softened even if the glass includes dopant, such as phosphorus pentoxide or boron oxide.

In the optical waveguide according to Embodiment 1, lower cladding layer 2 has the composition providing the softening temperature not lower than 580° C., and upper cladding layer 4 has the composition providing the softening temperature not higher than 550° C. The compositions prevents lower cladding layer 2 from deforming, and allows the optical waveguide to be manufactured at a low production cost since a temperature for the manufacturing may be low. The optical waveguide according to Embodiment 1 can be manufactured at a temperature lower than 1200° C., which is a softening temperature of silica glass. Moreover, if core 3 has a softening temperature not less than 600° C., the difference between the softening temperatures of lower cladding layer 2 and upper cladding layer 4 can be determined to be large.

For instance, glass made essentially of Na₂O or K₂O including at least SiO₂ and B₂O₃ may have a softening temperature considerably lower than that of silica glass made of SiO₂. Additive, such as fluorine, for the above-mentioned glass provides glass with a softening temperature not higher than 500° C. Fluorine crown glass may have a softening temperature not higher than 500° C.

Exemplary Embodiment 2

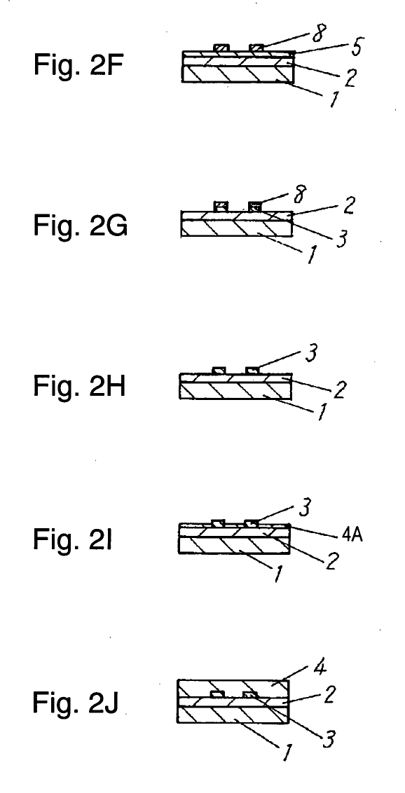

An optical waveguide according Exemplary Embodiment 2 has the same structure as an optical waveguide shown in FIG. 1. FIGS. 2A to 2J are cross-sectional views of the optical waveguide for illustrating processes of manufacturing the waveguide according to Embodiment 2.

Lower cladding layer 2 is formed on substrate 1 shown in FIG. 2A, as shown in FIG. 2B. Next, core layer 5 made of glass material is formed on lower cladding layer 2, as shown in FIG. 2C. Mask layer 6 is then formed on core layer 5, as shown in FIG. 2D. Mask layer 6 is made of silicon, metal, such as titanium, tungsten, nickel, or chrome, semi-conductor or alloys of them, and is formed by sputtering or vapor deposition. Resist is applied on mask layer 6 to form resist-pattern 7 on mask layer 6 by photo-lithography, as shown in FIG. 2E. Mask layer 6 is dry-etched to provide mask pattern 8, employing resist pattern 7 as a mask, as shown in FIG. 2F.

Thin resist pattern 7 can easily provide a higher dimensional accuracy. The etching rate of resist pattern 7, therefore, is preferably smaller than that of mask layer 6 in the etching process.

Next, core layer 5 is dry-etched to provide core 3, employing mask pattern 8 as a mask, as shown in FIG. 2G. The dry etching may employ reactive ion etching with CF₄, CHF₃, or gas including fluorocarbon, such as C₄F₈, sulfur compound gas, such as SF₆, rare gas, such as Ar or Xe, oxygen, hydrogen, or mixture of them as an etching gas.

Mask pattern 8 is a mask for patterning core layer 5 by etching, and is etched practically simultaneously to etching of core layer 5. Generally, thin mask pattern 8 can easily provide patterns accurately. The etching rate of core layer 5, therefore, is preferably larger than that of mask pattern 8 in etching process.

Including tungsten and silicon, mask pattern 8 can have a large etching rate. In this case, a layer composed of material including tungsten and silicon is applied first by sputtering to form mask layer 6. Mask layer 6 can be etched at a high etching rate with etching gas, such as CF₄, CHF₃, or gas including fluorocarbon, such as C₄F₈.

Mask layer 6 may be etched with plasma generated in vacuum equipment.

Next, mask pattern 8 is removed, thus providing core 3, as shown in FIG. 2H. Then, forming and heating of partial cladding layer 4A alternately are repeated, as shown in FIG. 2I, hence forming upper cladding layer 4 covering core 3 to provide the optical waveguide, as shown in FIG. 2J.

A method of forming upper cladding layer 4 shown in FIG. 2I will be described in detail.

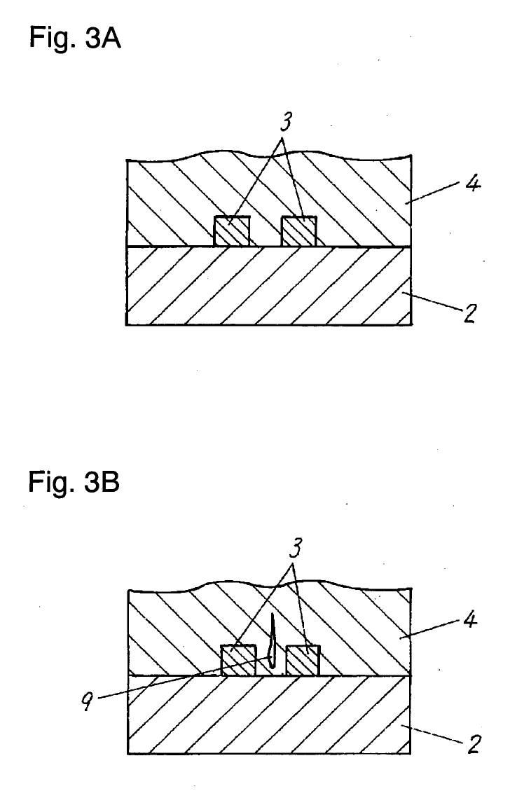

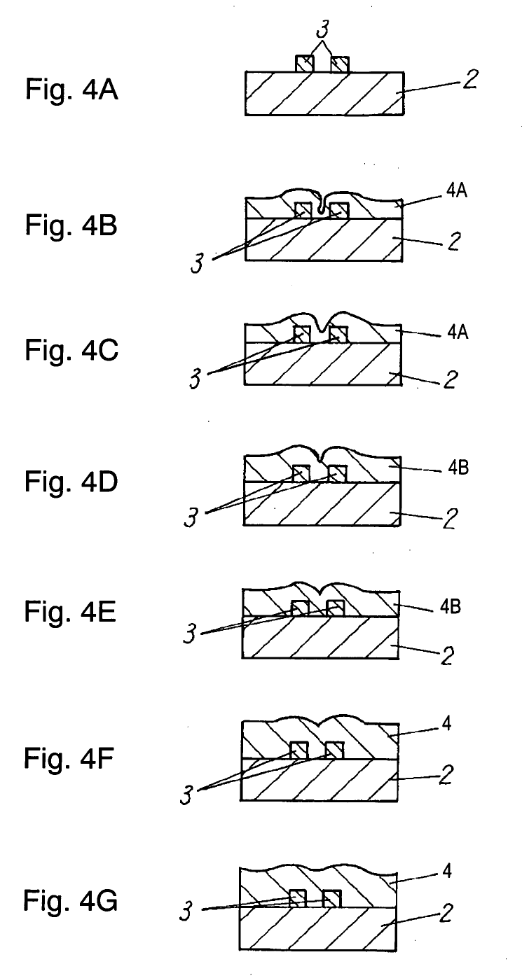

FIGS. 3A and 3B are cross-sectional views of the optical waveguide according to Embodiment 2. FIGS. 4A to 4G are cross-sectional views of the optical waveguide for illustrating processes of manufacturing the waveguide according to Embodiment 2.

Substrate 1 is not shown in FIGS. 3A to 4G. Lower cladding layer 2 may function as a portion of substrate 1.

Upper cladding layer 4 covering core 3 is formed on lower cladding layer 2. Upper cladding layer 4 made of multi-component glass material is formed by depositing, for example, a chemical film-forming method, such as chemical vapor deposition (CVD), or a physical film-forming method, such as sputtering or physical vapor deposition.

Forming of upper cladding layer 4 by the CVD is not preferable from the view point of production cost since multi-component gas material for the CVD is generally expensive. However, the CVD allows layer 4 to cover a rough surface reliably. Upper cladding layer 4 formed by the CVD, however, may not cover core 3 completely, and cover core 3 completely, causing hollow 9, as shown in FIG. 3B.

Forming upper cladding layer 4 by sputtering is generally preferable from the viewpoint of production cost. A sputtering target designed appropriately can form upper cladding layer 4 made of multi-component glass material having a desired composition. The composition of sputtering target seldom matches with that of upper cladding layer 4 strictly but generally matches with that of upper cladding layer 4. Designing of the composition of the sputtering target is important to precisely control physical properties of upper cladding layer 4, such as a refraction index and a thermal expansion coefficient. Differently from forming of a film on a flat plane, upper cladding layer 4 formed to cover core 3 may not cover core 3 completely. Namely, upper cladding layer 4 may not be provided around core 3, hence generating hollow 9 in upper cladding layer 4. Upper cladding layer 4 may not be formed uniformly, even while hollow 9 is not generated.

FIGS. 4A to 4G show processes of forming upper cladding layer 4 on lower cladding layer 2 while covering core 3.

First, core 3 is formed on lower cladding layer 2, as shown in FIG. 4A. Then, a predetermined amount of partial cladding layer 4A is deposited, as shown in FIG. 4B. Partial cladding layer 4A is softened by heating, as shown in FIG. 4C. Partial cladding layer 4A softened by the heating is flowable and cover core 3 without hollow 9. Material of cladding layer 4 is then deposited on partial cladding layer 4A and around core 3 to form partial cladding layer 4B, as shown in FIG. 4D. Then, partial cladding layer 4B is heated, as shown in FIG. 4E, thus forming upper cladding layer 4, as shown in FIG. 4F. Upper cladding layer 4 softened by the heating covers core 3 without the hollow in upper cladding layer 4, as shown in FIG. 4G.

As described above, upper cladding layer 4 is formed by repeating depositing and heating the partial cladding layers alternately, as shown in FIG. 3A.

The softening of upper cladding layer 4 can provide upper cladding layer 4 with homogeneous composition.

Upper cladding layer 4 has a softening temperature lower than that lower cladding layer 2. In a temperature range not higher than the softening temperature of lower cladding layer 2 and not lower than the softening temperature of upper cladding layer 4, lower cladding layer 2 is not softened, and upper cladding layer 4 is softened. This temperature, therefore, prevents lower cladding layer 2 from deforming in the manufacturing process shown in FIGS. 4A to 4G. Upper cladding layer 4 has a softening temperature lower than that of core 3. This prevents core 3 from deforming in the manufacturing process shown in FIGS. 4A to 4G.

A difference between the softening temperatures of lower cladding layer 2 and upper cladding layer 4 smaller than 50° C. is not preferable since a temperature needs to be controlled precisely. The difference between the softening temperatures not larger than 50° C. reliably prevents lower cladding layer 2 from deforming, due to a large tolerance in the heating temperature control

Whole upper cladding layer 4 can be deposited at once and heated, however cannot often cover core 3 completely. For instance, if hollow 9 is produced, hollow 9 remains in upper cladding layer 4 even after the heating, since it is difficult to remove bubbles in glass material. The depositing and heating of the predetermined amount of partial cladding layers 4A and 4B are repeated alternately, and provides upper cladding layer 4 without hollow 9 therein.

In the cases that core 3 has height H3 ranging from 5 μm to 10 μm, and that upper cladding layer 4 has thickness H4 of 20 μm, the depositing and heating of the partial cladding layers is preferably repeated alternately more than five times for having upper cladding layer 4 cover core 3 completely.

For instance, if core 3 has height H3 of 8 μm, and upper cladding layer 4 has thickness H4 of 20 μm, the depositing and heating of the partial cladding layers is repeated seven times. First, a partial cladding layer having a thickness of 4 μm is deposited. The partial cladding layer is heated for softening. Then, another partial cladding layer having a thickness of 3 μm is deposited and heated for softening. Similarly, the depositing and heating of a partial cladding layer having a thickness of 3 μm is repeated additional five times.

In the above description, the partial cladding layers having the thicknesses of 3 μm is deposited, however, a layer having a thickness other than 3 μm may be deposited. First, a partial cladding layer having a thickness of 2 μm is deposited and heated. Next, a partial cladding layer having a thickness of 3 μm is deposited on the partial cladding layer formed previously and heated. Namely, partial cladding layers having different thicknesses may be deposited for providing cladding layer 4. However, it takes a long time to deposit and stack a lot of thin partial cladding layers to form upper cladding layer 4. It also takes a long time to heat thick partial cladding layers to covering core 3 completely, and the thick layer may cause hollow 9 although being heated. Therefore, materials for partial cladding layers 4A and 4B is preferably deposited for a short time.

Cladding layer 4 may be formed while substrate 1 including lower cladding layer 2 and core 3 on layer 2 rotates. This allows upper cladding layer 4 to have homogeneous composition. Substrate 1 may rotate around a point in substrate 1 or in a point out of substrate 1 as a rotation center, or may rotate simultaneously around these points as rotation centers.

Upper cladding layer 4 may be deposited while substrate 1 is heated. This allows layer 4 to be bond to core 3 strongly, and shorten a time for heating layer 4 to have a temperature reach the softening temperature. If substrate 1 is heated up to a temperature higher than a transition temperature of the glass material composing upper cladding layer 4, substrate 1 may be re-evaporated or crystallized, and reduces a production yield of the optical waveguide. The heating temperature to form upper cladding layer 4 is preferably lower than the transition temperature of upper cladding layer 4, more preferably lower than the transition temperature minus 50° C. to improve the production yield, hence enabling the optical waveguide to be manufactured inexpensively. In the case that upper cladding layer 4 has a transition temperature of 480° C., partial cladding layers 4A and 4B are formed at 300° C. and are heated up to 500° C. for softening.

When glass including oxides is heated, oxygen depletion may occur at a high temperature. The oxides, therefore, is preferably heated in an ambient atmosphere including oxygen to prevent the oxygen depletion.

When a partial cladding layer composed of material including oxides is formed by sputtering, oxygen depletion may often occur at a high sputtering rate. The partial cladding layer may be heated in an ambient atmosphere including oxygen, and thereby, can make up for shortages of oxygen, thus preventing the material from oxygen depletion. This shortens a time for forming the layer. Namely, partial cladding layers are deposited by sputtering at a high sputtering rate for a short time while avoiding the oxygen depletion. Thus, the partial cladding layers are heated in an ambient atmosphere including oxygen, reducing the oxygen depletion and providing upper cladding layer 4 with homogeneous composition.

The time for forming upper cladding layer 4 can be further shortened not only by the sputtering and heating but also by cooling the layer from the softening temperature to a temperature for depositing of the layer. Rapid cooling of upper cladding layer 4 may cause residual strains in glass material composing upper cladding layer 4.

In cooling of partial cladding layers 4A and 4B from the softening temperature to a temperature required for deposition, layers 4A and 4B is cooled at a rate of 1 K/min within a temperature range of 100° C. from a temperature higher than the transition temperature of upper cladding layer 4 by 50° C. to a temperature lower than the transition temperature of upper cladding layer 4 by 50° C., thereby not causing the strains in the glass material

Even if being cooled rapidly, partial cladding layers 4A and 4B do not cause the strains in the glass material at a temperature higher than the transition temperature plus 50° C. In this temperature range, partial cladding layers 4A and 4B are cooled at a rate faster than 1 K/min with a cooling device, hence shortening a time for forming the layers and reducing a production cost of the optical waveguide. However, excessively rapid cooling may produce cracks in the cladding layers. The cladding layers may be cooled down preferably at a rate slower than 100 K/min.

Partial cladding layers 4A and 4B at a temperature lower than the transition temperature of upper cladding layer 4 minus 50° C. may be cooled down preferably at a room temperature. Rapid cooling at this temperature range may cause cracks in glass material of partial cladding layers 4A and 4B. The cladding layers hardly cause the strains in the case that the layers are cooled rapidly at a temperature near the transition temperature. Howver, the layers more hardly causes the strains in the case that the layers are cooled rapidly at a temperature higher than the transition temperature plus 50° C.

Thermal hysteresis of the cladding layer may preferably be controlled during the cooling of the layer from the temperature for softening to the temperature for depositing. For example, the cladding layer may be cooled down at a rate faster than 1 K/min and slower than 100 K/min in the temperature range from the softening temperature to the temperature higher than the transition temperature of upper cladding layer 4 plus 50° C. Then, cladding layers is cooled down at a rate slower than 1 K/min within a temperature range of 100° C. from a temperature higher than the transition temperature of upper cladding layer 4 by 50° C. to a temperature lower than the transition temperature of upper cladding layer 4 by 50° C. This operation shortens a time for forming the layer and provides the cladding layer without strains in glass materials.

Alternatively, a temperature T within the temperature range of 100° C. from a temperature higher than the transition temperature of upper cladding layer 4 by 50° C. to a temperature lower than the transition temperature of upper cladding layer 4 by 50° C. is predetermined. The cladding layers are cooled down at a rate faster than 1 K/min and slower than 100 K/min in the temperature range from the softening temperature to the temperature T. Then, the cladding layers are kept at the temperature T for a period not less than 10 minutes and not more than 60 minutes. This operation can control the temperature of the cladding layers reliably since the cladding layers are kept in the predetermined temperature. Accordingly, this operation shortens a time for forming the layers and prevents the cladding layers more reliably from strains in glass material. Cooling rates, heating conditions for softening, heating conditions of substrate for cladding layer depositions may be optimized according to glass composition of the cladding layers.

The method of forming cladding layer 4 by deposition is described above. A single apparatus may both deposit cladding layer 4 and heat the layer to soften cladding layer 4, thereby providing cladding layer 4 at high productivity. The depositing of the layers and heating of the layer for softening may be performed in the same processing chamber, and the cooling of the layer may be performed in a chamber different from the processing chamber, thereby allowing the depositing/heating and the cooling to be preferably controlled individually. This arrangement enables a cladding layer of an optical waveguide to be heated for softening the layer while enabling a cladding layer of another optical waveguide to be cooled. This arrangement, therefore, shorten an average manufacturing time per an optical waveguide more than a method of manufacturing optical waveguides sequentially. In this case, a time for the cooling may preferably be determined to be a time similar to a total time for the depositing and heating of the cladding layer. The determined time shortens the total manufacturing time since reducing a waste time for waiting.

1. An optical waveguide comprising:
a first cladding layer made of glass material having a first softening temperature and a first refraction index;
a core made of glass material provided on the first cladding layer, the core having a second refraction index larger than the first refraction index; and
a second cladding layer covering the core and made of glass material including at least one of alkali element, alkali-earth element, and rare-earth element, the second cladding layer having a second softening temperature lower than the first softening temperature and having a third refraction index smaller than the second refraction index.

2. The optical waveguide of claim 1, wherein the second softening temperature is lower than the first softening temperature minus 50° C.

3. The optical waveguide of claim 1, wherein the first softening temperature is higher than 580° C., and the second softening temperature is lower than 550° C.

4. A method of manufacturing an optical waveguide, comprising:
providing a first cladding layer made of first glass material;
forming a core on the first cladding layer, the core being made of second glass material having a refraction index larger than a refraction index of the first glass material;
forming a second cladding layer covering the core, the second cladding layer being made of third glass material having a refraction index smaller than the refraction index of the second glass material,
wherein said forming of the second cladding layer comprises:
providing a first partial cladding layer made of the third glass material on the core;
heating the first partial cladding layer up to a first temperature;
providing a second partial cladding layer made of the third glass material on the first partial cladding layer after said heating of the first partial cladding layer; and
heating the second partial cladding layer.

5. The method of claim 4, wherein the third glass material includes at least one of alkali element, alkali-earth element, and rare-earth element.

6. The method of claim 4, wherein said forming of the first partial cladding layer comprises
providing the third glass material on the core at a temperature lower than a transition temperature of the third glass material minus 50° C.

7. The method of claim 4, wherein said forming of the second partial cladding layer comprises
providing the third glass material on the first partial cladding layer at a temperature lower than a transition temperature of the third glass material minus 50° C.

8. The method of claim 4, wherein said heating of the first partial cladding layer comprises
heating the first partial cladding layer in an ambient atmosphere including oxygen.

9. The method of claim 4, wherein said heating of the second partial cladding layer comprises
heating the second partial cladding layer in an ambient atmosphere including oxygen.

10. The method of claim 4, wherein said forming of the second cladding layer further comprises
after said heating of the first partial cladding layer, cooling the first partial cladding layer from the first temperature to a second temperature higher than a transition temperature of the third glass material by 50° C. at a cooling rate faster than 1 K/min and slower than 100 K/min.

11. The method of claim 10, wherein said forming of the second cladding layer further comprises
after said cooling of the first partial cladding layer, cooling the first partial cladding layer from the second temperature to a temperature lower than the transition temperature of the third glass material by 50° C. at a cooling rate slower than 1 K/min.

12. The method of claim 4, wherein said forming of the second cladding layer further comprises
after said heating of the first partial cladding layer, cooling the first partial cladding layer from a temperature higher than a transition temperature of the third glass material by 50° C. to a temperature lower than the transition temperature by 50° C. at a cooling rate slower than 1 K/min.

13. The method of claim 4, wherein said forming of the second cladding layer further comprises:
after said heating of the first partial cladding layer, cooling the first partial cladding layer from the first temperature to a predetermined temperature at a cooling rate faster than 1 K/min and slower than 100 K/min, the predetermined temperature being between a temperature higher than a transition temperature of the third glass material by 50° C. and a temperature lower than the transition temperature by 50° C.; and
after said cooling of the first partial cladding layer, keeping a temperature of the first cladding layer at the predetermined temperature

14. The method of claim 13, wherein said keeping of the temperature of the first partial cladding layer at the predetermined temperature comprises keeping the temperature of the first partial cladding layer at the predetermined temperature for not less than 10 minutes and not more than 60 minutes.
